(19) United States
(12) Patent Application Publication
(10) Pub. No.: US 2023/0030973 A1
(43) Pub. Date: Feb. 2, 2023

(54) CHANGE OF FIRMWARE SETTINGS

(71) Applicant: Hewlett-Packard Development Company, L.P., Spring, TX (US)

(72) Inventors: Tao Sheng Chu, Taipei City (TW); Chan Liang Lin, Taipei City (TW); Chia Ho Cheng, Taipei City (TW); Chin-Ta Lo, Taipei City (TW); Chihyuan Chiu, Taipei City (TW); Chieh Hao Chen, Taipei City (TW)

(73) Assignee: Hewlett-Packard Development Company, L.P., Spring, TX (US)

(21) Appl. No.: 17/789,600

(22) PCT Filed: Jan. 10, 2020
(86) PCT No.: PCT/US2020/013188

§ 371 Date: Jun. 28, 2022

(51) Int. Cl. G06F 8/70; G06F 3/04842

(52) U.S. Cl. CPC G06F 8/70; G06F 3/04842

(57) ABSTRACT

Examples of computing devices and methods for changing firmware settings of a computing device are described herein. In an example, a request for change in a firmware setting is received. In response to the request, the firmware setting is changed in real-time.

### BACKGROUND

Computing devices, such as desktop computers, All-in-One (AiO) computers, etc., utilize a computer firmware during a booting process to recognize, initialize, and test the hardware present in the computing device in addition to loading an operating system (OS). Firmware platforms, such as basic input/output system (BIOS) or unified extensible firmware interface (UEFI), allow a variety of different parameters to be set, such as hardware and booting configuration parameters.

### BRIEF DESCRIPTION OF FIGURES

The detailed description is provided with reference to the accompanying figures, wherein:

FIG. 1 illustrates a computing device for changing a firmware setting thereof, according to an example;

FIG. 2 illustrates a computing device for changing a firmware setting thereof, according to an example;

FIG. 3 illustrates a method for changing a firmware setting of a computing device, according to an example;

FIG. 4 illustrates a method for changing a firmware setting of a computing device, according to an example; and

FIG. 5 illustrates a non-transitory computer readable medium for authenticating a write request to a controller, according to an example.

### DETAILED DESCRIPTION

Computing devices, such as an All-in-One (AiO) personal computer (PC) or a full-sized desktop PC, include a firmware menu which include system settings, such as hardware settings. The firmware menu may also include control settings for controlling functionality of various devices and components connected to or integrated into a computing device. The computing devices enable a user to access the firmware menu, after completion of a Power-On-Self-Test (POST) during booting up of the computing device.

The user may press a key or a combination of keys within a given time frame, to access the firmware menu. Thus, to be able to access the firmware menu for changing or viewing the system settings, the user may have to be prompt. If the user is unable to timely press the desired key(s), the user may have to re-boot the computing device to access the firmware menu. Thus, an attempt to access the firmware menu necessitate a large number of instances of rebooting the computing device which may be inconvenient and time consuming.

During a working state of the computing device, i.e., when the computing device is in use, a user may intend to access the firmware menu to change or set a firmware setting. To bring the change in the firmware setting into effect, the user may have to either immediately re-boot the computing device or may have to wait for a subsequent boot. This may cause hinderance in an ongoing activity of the computing device, thereby effecting efficiency of the computing device.

The present subject matter discloses example approaches for changing a firmware setting of a computing device. For example, a controller such as an embedded controller of the computing device may facilitate in changing the firmware setting even when a processing resource, such as a central processing unit (CPU), of the computing device is in a sleeping state. The firmware setting be associated with an operation state of an external device or a component, connected to or integrated into the computing device. Examples of the firmware setting include, but are not limited to, a wireless charger pad setting, a Universal Serial Bus (USB) fast charging setting, and a Bluetooth® speaker setting.

As per the present subject matter, a user of the computing device may select a firmware setting irrespective of an operational state of the CPU of the computing device. For example, the user may perform the selection of the firmware setting through an on-screen interface while the CPU is in a sleeping state or a working state. The selection by the user is provided to a controller, for example an embedder controller, separate from the CPU of the computing device. Based on the selection, the controller may change the current state of the selected firmware setting, in a firmware of the computing device. The controller may implement the change in the current state of the firmware setting by changing the operation state of the external device or the component, connected to or integrated into the computing device, in real-time, without re-booting the computing device.

Accordingly, the present subject matter facilitates in providing access to the firmware menu any time using the on-screen interface of the computing device. In addition, the current state of the firmware setting, and the operational state of the corresponding device or component associated with the firmware setting may be implemented in real-time without having to reboot the computing device.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

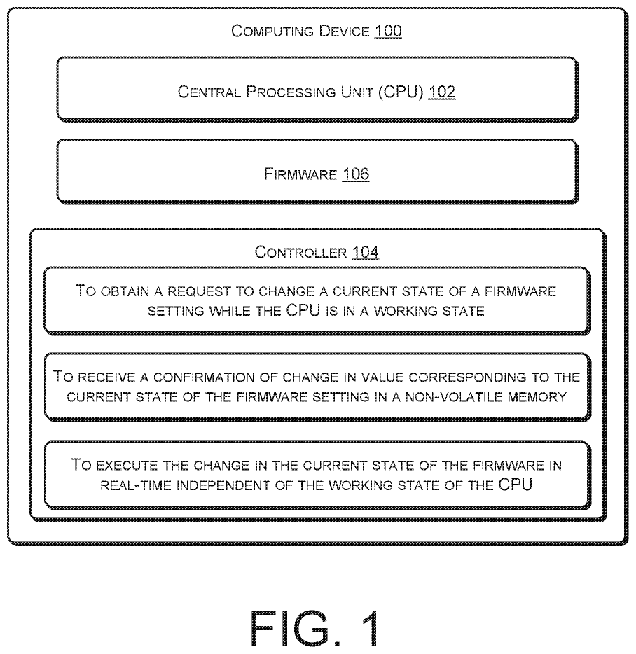

The manner in which the computing device and method are implemented are explained in detail with respect to FIGS. 1-5. While aspects of described computing device and method can be implemented in any number of different electronic devices, environments, and/or implementations, the examples are described in the context of the following system(s). It is to be noted that drawings of the present subject matter shown here are for illustrative purposes and are not drawn to scale.

FIG. 1 illustrates a computing device 100 for changing a firmware setting of the computing device 100, according to an example. Examples of the computing device 100 may include an All-in-One (AiO) personal computer (PC) and a full-sized desktop PC. The computing device 100 may include a central processing unit (CPU) 102. The CPU 102 may include microprocessors, microcomputers, microcontrollers, digital signal processors, processors, state machines, logic circuitries, and/or any other devices that manipulate signals and data based on computer-readable instructions. Further, functions of the various elements shown in the figures, including any functional blocks labelled as “CPU”, may be provided through the use of dedicated hardware as well as hardware capable of executing computer-readable instructions.

Further, the computing device 100 may include a controller 104 coupled to the CPU 102. The controller 104 may be implemented as an embedded controller, a microcontroller, a microprocessor, a functional block, logic, or other circuit or collection of circuits capable of performing the functions described herein. The controller 104 may be coupled to a monitor (not shown) of the computing device. Therefore, any input, regarding change in the firmware settings, received at the monitor may be processed by the controller 104 without involving the CPU 102.

The computing device 100 may also include a firmware 106 that may be coupled to the controller 104. The firmware 106 may include a program that may be written to a non-volatile memory (not shown) of the computing device 100. Examples of the firmware 106 may include Basic input/output System (BIOS) or Unified Extensible Firmware Interface (UEFI).

In an example, the controller 104 may obtain a request to change a current state of a firmware setting of the computing device 100 while the CPU 102 is in a working state. Examples of the firmware setting may include, but are not limited to, a wireless charger pad setting, a Universal Serial Bus (USB) fast charging setting, and a Bluetooth® speaker setting. The working state or the S0 state of the CPU 102 may be indicative of an operational state of the CPU 102, i.e., when the CPU 102 is being used for performing certain activity.

In the present example, the controller 104 may obtain the request based on a user input. For example, a user may select the firmware setting for changing the current state through an on-screen interface of the computing device 100. The on-screen interface may provide access to a list of settings, such as firmware settings that may be set or modified by a user of the computing device 100. The on-screen interface is provided on a display unit, such as the monitor, of the computing device 100.

Upon receiving the request, the controller 104 may transmit the request to the firmware 106 for changing a value corresponding to the current state of the firmware setting in the NVM associated with the firmware 106. Upon receiving a confirmation of the change in the value, the controller 104 may execute the change in the current state of the firmware setting in real-time. The controller 104 executes the change in the firmware setting independent of the working state of the CPU 102.

Therefore, the present subject matter facilitates a user to change a firmware setting at any time in a powered-ON state of the computing device 100, irrespective of whether the CPU 102 is in a sleeping state or a working state. The sleeping state of the CPU 102 is indicative of a state of the CPU 102 in which the CPU 102 may appear to be OFF because of reduced power consumption but may retain enough context to return to the working state without restarting the operating system.

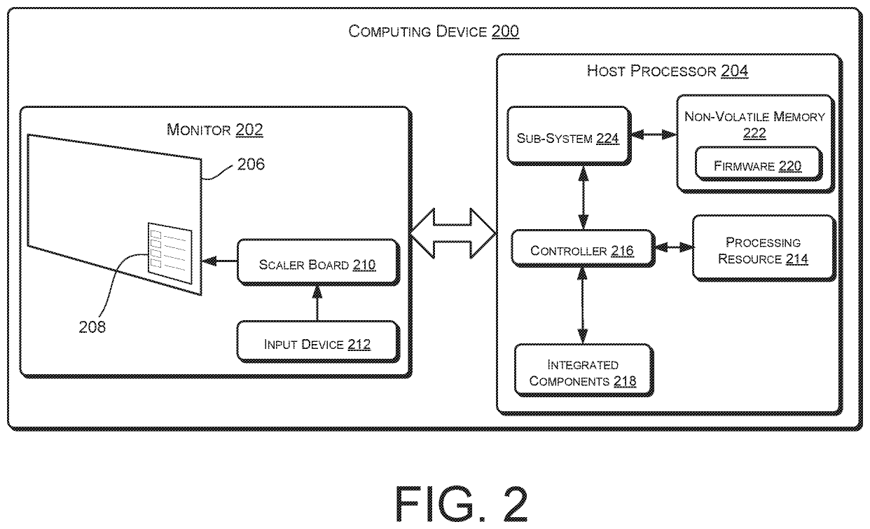

FIG. 2 illustrates a computing device 200 for changing a firmware setting of the computing device 200, according to an example. In an example, the computing device 200 may be similar to the computing device 100. The computing device 200 may include a monitor 202 and a host computer 204. In one example, the monitor 202 and the host computer 204 may be part of a same housing (not shown), such as in case of All-in-One (AiO) computers. In another example, the monitor 202 and the host computer 204 may be part of separate housings (not shown), such as in case of a desktop personal computer (PC).

The monitor 202 may include various components that may facilitate the computing device 200 to display content. For example, the monitor 202 may include a display panel 206. Examples of the display panel 206 may include, but are not limited to, liquid crystal displays (LCDs), plasma displays, and light emitting diode (LED) based displays. In an example, the display panel 206 may be a touch panel. The display panel 206 may also include an on-screen menu 208. The on-screen menu 208 may be a user interface for providing access to a list of settings, such as firmware settings that may be set or modified by a user of the computing device 200.

Further, the monitor 202 may include a scaler board 210 coupled to the display panel 206. In an example, the scaler board 210 represents front-end electronics of the monitor 202 to receive digital signals from the host computer 204. The scaler board 210 may process the digital signals to provide analog video signals to the display panel 206. The processing performed by the scaler board 210 may include image processing, such as scaling, picture-in-picture (PIP) image generation, backlight controlling, and other processing of digital video data.

The monitor 202 may further include an input unit 212. The input unit 212 may facilitate the user to provide input or select a particular firmware setting from the on-screen menu 208. Examples of the input unit 212 may include, but are not limited to, a mechanical push button and a touch panel. The user may use the input unit 212 to access the on-screen menu 208 to select a particular firmware setting for being modified or set. The selection made by the user is received by the scaler board 210 for being communicated further to the host computer 204.

Referring to the host computer 204, the host computer 204 may include a processing resource 214, such as a central processing unit (CPU). The processing resource 214 may be similar to the CPU 102. The processing resource 214 receives data input, executes instructions, and processes information. The processing resource 214 communicates with input/output (I/O) devices, which send and receive data to and from the processing resource 214. Further, the host computer 204 may include a controller 216. The controller 216 may be similar to the controller 104. The controller 216 may be coupled to the scaler board 210, such that the scaler board 210 may provide the selection of the firmware setting by the user to the controller 216 over an Inter-Integrated Circuit (I2C) serial interface portion of a video signal cable, Universal Asynchronous Receiver/Transmitter circuit (UART), Recommended Standard (RS) 232, or Universal Serial Bus (USB) connection.

In an example implementation, the controller 216 may be coupled to a power supply control unit (not shown), to manage or control consumption of power supply by the computing device 200. Accordingly, the controller 216 facilitates in turning ON/OFF of or adjusting the power of the processing resource 214, display panel 206, and/or the integrated components 218, in real-time, to prevent overload situation.

The host computer 204 may include integrated components 218 that may be connected to the controller 216. Examples of the integrated components, may include, but are not limited to, a Bluetooth® speaker, a USB fast charging port, and a wireless charging pad. In an example, the controller 216 may be coupled to the integrated components over an I2C interface or a UART circuit. Even though the controller 216 is depicted as coupled to the integrated components 218, the controller 216 may be coupled to some peripheral devices.

Further, the host computer 204 may include a firmware 220 that may be communicatively coupled to the controller 216. In an example, the firmware 220 may be similar to the firmware 106. The firmware 106 may include a program that may be written to the host computer 204. In an example, the firmware 220 may be written into a non-volatile memory (NVM) 222. Examples of the NVM 222 may include, but are not limited to, Read-Only Memory (ROM), erasable programmable ROM, flash memories, hard disks, optical disks, and magnetic tapes.

The host computer 204 may also include a sub-system 224 coupled to the controller 216. The controller 216 may communicate with the sub-system 224 over an Enhanced Serial Peripheral Interface (eSPI) and a Low Pin Count interface (LPC). The sub-system 224 may also be in communication with the firmware 220. The sub-system 224 may be indicative of a service provider that performs functions, upon being requested. Examples of the sub-system 224 may include, but are not limited to, an Intel Management Engine (ME) and an AMD Platform Security Processor (PSP). In an example implementation, the NVM 222 and the sub-system 224 may be provided on a chipset (not shown), such as a Platform Control Hub (PCH) or an Accelerated Programming Unit (APU).

In operation, a user of the computing device 200 may access the on-screen menu 208, such as through on-screen display buttons. The user may select a firmware setting, for example, wireless charger pad setting, for being modified through the on-screen menu 208. Examples of the firmware setting may include, but are not limited to, a USB fast charging setting, a Bluetooth® speaker setting, a base frequency setting of the processing resource 214, a core voltage setting of the processing resource 214, and a clock ratio setting of the processing resource 214.

The scaler board 210 may receive the selection of the wireless charger pad setting from on-screen menu 208 and share the selection with the controller 216. The controller 216 may translate the selection received from the scaler board 210 into a settings change command. The settings change command may include instructions for changing a value corresponding to the wireless charger pad in the firmware 220. The settings change command may be different for different firmware settings.

In an example implementation, the controller 216 may, after translating the selection, transmit the settings change command to the sub-system 224 over the I2C serial interface, the UART circuit, RS 232, or the USB connection. The sub-system 224 may, in accordance with the settings change command, change the value corresponding to the wireless charger pad in the firmware 222. Thereafter, the sub-system 224 may provide a confirmation to the controller 216 to indicate that the value corresponding to the wireless charger pad has been successfully changed in the firmware 222.

The controller 216 may, upon receiving the confirmation, change a current state of the wireless charger pad, in real-time. For example, if the current state of the wireless charger pad is ‘OFF’, in response to the change in value, the controller 216 may change the state of the wireless charger pad to ‘ON’. In addition, the controller 216 may a notification on the display panel 206 indicating the change in the wireless charger pad setting.

As the controller 216 is separate from the processing resource 214 of the computing device 200, the change in the firmware setting of the computing device 200 may be performed independent of an operational state of the processing resource 214. For example, the computing device 200 may be used in a gaming mode or a personal computer mode. In both these modes, the processing resource 214 of the computing device 200 may be involved in the operations and thus the processing resource 214 is in the working state or an S0 state. In the present example, in the gaming mode, the on-screen menu 208 of the computing device 200 may provide over-clocking features. The user may thus choose to change a base frequency setting of the processing resource 214, a core voltage setting of the processing resource 214, a clock ratio setting of the processing resource 214 or Dynamic Random-Access Memory (DRAM) frequency in real-time, while the processing resource is in the working state.

In an example implementation, the user of the computing device 200 may create pre-defined profiles. Using the on-screen menu 208, the user may select any of the pre-defined profiles for changing a firmware setting in accordance with the profile.

In another example, the computing device 200 may be used in a monitor mode or a speaker mode. In these modes, the processing resource 214 may be in a suspend to Random Access Memory (RAM) state or an S3 state, a hibernation state or an S4 state, a soft off state or an S5 state, and a low power idle (Modern Standby) state.

Further, the controller 216 facilitates in changing the value corresponding to the selected firmware setting as well as change in the current state of a component associated with the selected firmware setting in real-time. Therefore, the user of the computing device 200 is able to make changes in the firmware settings, without having to re-boot the computing device 200.

In another example implementation, the controller 216 may, upon receiving the selection of the firmware setting, implement the requested change in the selected firmware setting without requesting the sub-system 224 to change the value of the firmware setting. For example, the user may select the Bluetooth® speaker setting for turning down a volume of a Bluetooth® speaker. The controller 216 may, upon receiving the selection of the firmware setting, directly change a setting of the Bluetooth® speaker in real-time. The controller 216 may accordingly confirm the changes in the firmware setting to the scaler board 210. The scaler board 210 may display the changes in the firmware setting in real-time. For example, the scaler board 210 may display the Bluetooth® speaker volume bar, connect/disconnect status on the display panel 206.

Although the present subject matter is explained with respect to changing a firmware setting, the user may select a firmware setting from the on-screen menu 208 for being set up. For example, the user may request pairing of Bluetooth® speaker with a remote compatible audio source.

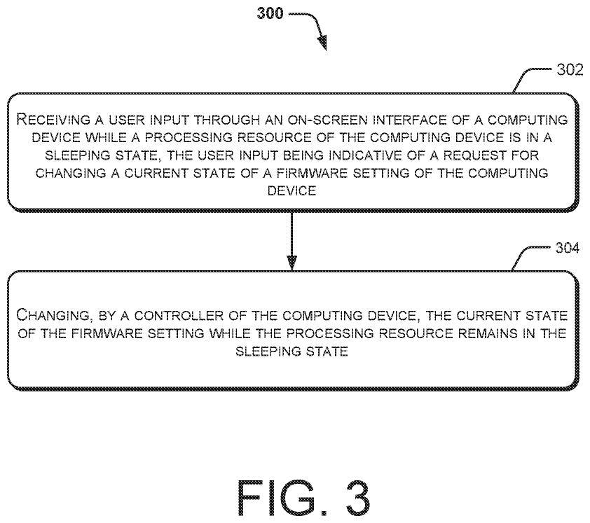

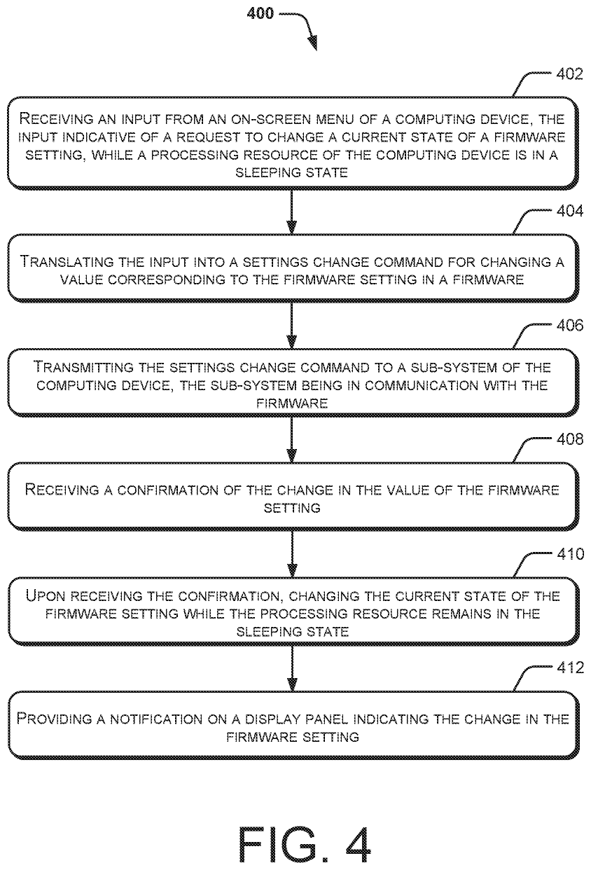

FIGS. 3 and 4 illustrate methods 300 and 400 for changing firmware settings of a computing device, according to examples of the present subject matter. The methods 300 and 400 may be described in the general context of computer executable instructions. The methods 300 and 400 can be implemented by processor(s) or device(s) through any suitable hardware, a non-transitory machine readable medium, or a combination thereof. Further, although the methods 300 and 400 are described in the context of a device that is similar to the computing device 100, other suitable devices or systems may be used for execution of the methods 300 and 400.

The order in which the methods 300 and 400 are described is not intended to be construed as a limitation, and any number of the described method blocks may be combined in any order to implement the methods 300 and 400, or an alternative method. In some example, blocks of the methods 300 and 400 may be executed based on instructions stored in a non-transitory computer-readable medium. The non-transitory computer-readable medium may include, for example, digital memories, magnetic storage media, such as a magnetic disks and magnetic tapes, hard drives, or optically readable digital data storage media.

Referring to FIG. 3, at block 302, a user input may be received at a computing device while a processing resource of the computing device is in a sleeping state. In an example implementation, the user input is received through an on-screen menu of the computing device. The user input may be indicative of a request for changing a current state of a firmware setting of the computing device. In an example implementation, the user input may be received by a display panel of the computing device. In an example, the sleeping state of the processing resource is indicative of a state of the processing resource in which the processing resource may appear to be OFF because of reduced power consumption but may retain enough context to return to the working state without restarting the operating system.

At block 304, the method includes changing the current state of the firmware setting while the processing resource remains in the sleeping state. In an example implementation, the current state may be changed by a controller of the computing device. The controller may be coupled to the display panel of the computing device to receive the request for change in the current state of the firmware setting.

Now referring to FIG. 4, at block 402, the method 400 includes receiving an input from an on-screen menu of a computing device. For example, the user may provide an input through mechanical buttons provided on a monitor of the computing device or a touch screen of the display panel. The input being indicative of a request to change a current state of a firmware setting, while a processing resource of the computing device is in a sleeping state. Examples of the sleeping state of the processing resource includes one of a suspend to Random Access Memory (RAM) (S3) state, a hibernation (S4) state, a soft off (S5) state, and a low power idle (Modern Standby) state.

In an example implementation, the controller of a host computer of the computing device may receive the input from a scaler board of the monitor of the computing device. The controller may be implemented as an embedded controller, a microcontroller, a microprocessor, a functional block, logic, or other circuit or collection of circuits capable of performing the functions described herein. The controller may be coupled to the monitor of the computing device.

At block 404, the method 400 includes translating the input into a settings change command. The settings change command is for changing a value corresponding to the firmware setting in a firmware in the computing device. In an example, the controller may translate the input received from the scaler board into the settings change command. In an example, firmware may include basic input/output system (BIOS) or unified extensible firmware interface (UEFI).

At block 406, the method 400 includes forwarding the settings change command to a sub-system of the computing device. The sub-system may be indicative of a service provider that performs functions, upon being requested. Examples of the sub-system may include, but are not limited to, an Intel Management Engine (ME) and an AMD Platform Security Processor (PSP). In an example, the controller may transmit the settings change command to the sub-system over an Enhanced Serial Peripheral Interface (eSPI) and a Low Pin Count interface (LPC).

At block 408, the method 400 includes receiving a confirmation of the change in the value of the firmware setting. In an example, the controller may receive the confirmation from the sub-system.

At block 410, the method 400 includes upon receiving the confirmation, changing the current state of the firmware setting while the processing resource remains in the sleeping state. In an example, the controller may change the current state of a component associated with the firmware setting. For instance, if the user has requested a change in a Universal Serial Bus (USB) fast charging port setting, i.e., from ON state to OFF state, the sub-system may change the value of the USB fast charging port setting in the firmware and confirm to the controller. The controller may upon receiving the confirmation, change the USB fast charging port to an OFF state.

Further, at block 412, the method 400 includes providing a notification on the display panel indicating the change in the firmware setting. For example, the controller may communicate with the scaler board to provide the notification on the display panel.

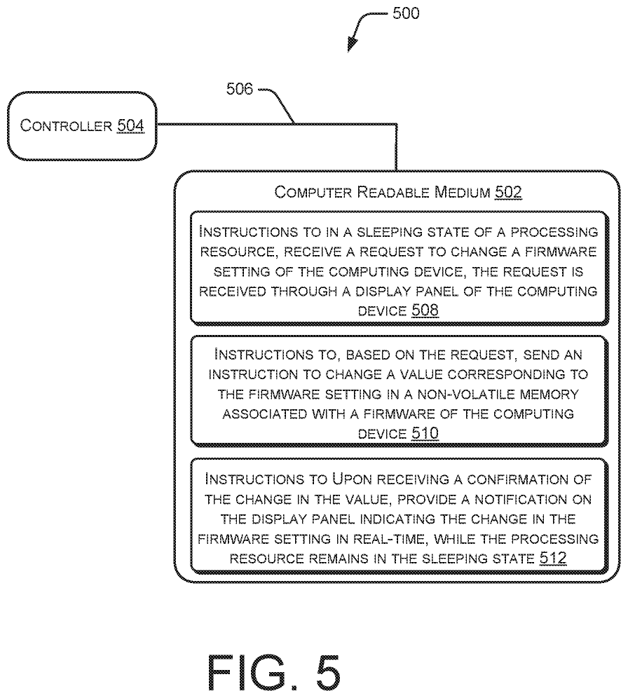

FIG. 5 illustrates an example system environment 500 using a non-transitory computer-readable medium 502 for changing a firmware setting of a computing device, such as the computing device 100, according to an example of the present subject matter. The system environment 500 includes a controller 504 communicatively coupled to the non-transitory computer-readable medium 502 through a communication link 506. For example, the controller 504 may be an embedded controller, separate from a central processing unit, of a computing system, such as the computing device, for fetching and executing computer-readable instructions from the non-transitory computer-readable medium 502.

The non-transitory computer-readable medium 502 may be, for example, an internal memory device or an external memory device. In one example, the communication link 506 may be a direct communication link, such as one formed through a memory read/write interface. In another example, the communication link 506 may be an indirect communication link, such as one formed through a network interface. In such a case, the controller 504 may access the non-transitory computer-readable medium 502 through a network (not shown).

In an example, the non-transitory computer-readable medium 502 includes a set of computer-readable and executable instructions for changing a firmware setting of the computing device. The set of computer-readable instructions may include instructions as explained in conjunction with FIGS. 1 to 4. The set of computer-readable instructions, referred to as instructions hereinafter, may be accessed by the controller 504 through the communication link 506 and subsequently executed to perform acts for changing a firmware setting of the computing device.

Referring to FIG. 5, in an example, the non-transitory computer-readable medium 502 may include instructions 508 to receive a request to change a firmware setting of the computing device. In an example, the firmware setting may include a wireless charger pad setting, a Universal Serial Bus (USB) fast charging setting, a Bluetooth® speaker setting, a base frequency setting of a processing resource, a core voltage setting of the processing resource, or a clock ratio setting of the processing resource. In an example implementation, the request may be received through a display panel of the computing device. The display panel may include an on-screen menu which may be accessed by a user through an input unit, such as on-screen buttons or a touch panel.

In an example implementation, the receive request is obtained in a sleeping state of the processing resource, such as a central processing unit (CPU) which is different from the controller, of the computing device. The sleeping state of the processing resource is indicative of a state of the processing resource in which the processing resource may appear to be OFF because of reduced power consumption but may retain enough context to return to the working state without restarting the operating system.

For example, the sleeping state may include a suspend to Random Access Memory (RAM) (S3) state, a hibernation (S4) state, a soft off (S5) state, or a low power idle (Modern Standby) state. For example, when the computing device may be used in a monitor mode or a speaker mode, the processing resource of the computing device may not be working.

The non-transitory computer-readable medium 502 may also include instructions 510 to based on the request, send an instruction to change a value corresponding to the firmware setting in a non-volatile memory (NVM) associated with the firmware in the computing device. In an example implementation, the controller 504 may send the instructions to a sub-system of the computing device. The sub-system may include a management engine or a platform security processor. The sub-system may be in communication with the firmware and may change the value pertaining to the current state of the particular firmware setting in the NVM.

The non-transitory computer-readable medium 502 may include instructions 512 to upon receiving a confirmation of the change in the value, provide a notification on the display panel indicating the change in the firmware setting. In an example, firmware settings are changed in real-time while the processing resource of the computing device remains in the sleeping state.

Although aspects for the present disclosure have been described in a language specific to structural features and/or methods, it is to be understood that the appended claims are not limited to the specific features or methods described herein. Rather, the specific features and methods are disclosed as examples of the present disclosure.

We claim:

1. A method comprising:
receiving a user input through an on-screen interface of a computing device while a processing resource of the computing device is in a sleeping state, the user input being indicative of a request for changing a current state of a firmware setting of the computing device; and
changing, by a controller of the computing device, the current state of the firmware setting while the processing resource remains in the sleeping state.

2. The method as claimed in claim 1, wherein the sleeping state of the processing resource comprises one of a suspend to Random Access Memory (RAM) (S3) state, a hibernation (S4) state, a soft off (S5) state, and a low power idle (Modern Standby) state.

3. The method as claimed in claim 1, wherein the firmware setting comprises a wireless charger pad setting, a Universal Serial Bus (USB) fast charging setting, a Bluetooth® speaker setting, a base frequency setting of the processing resource, a core voltage setting of the processing resource, and a clock ratio setting of the processing resource.

4. The method as claimed in claim 1, wherein changing the current state comprises changing a value corresponding to the current state of the firmware setting in a Non-Volatile Memory (NVM) of the computing device.

5. The method as claimed in claim 1, wherein the method comprises, providing a confirmation upon the change in the current state of the firmware setting on a display panel of the computing device, while the processing resource is in the sleeping state.

6. The method as claimed in claim 1, wherein the computing device is in one of a speaker mode and a monitor mode.

7. A computing device comprising:
a central processing unit;
a controller coupled to the central processing unit, the controller is to,
obtain a request to change a current state of a firmware setting of the computing device while the central processing unit is in a working state, wherein the firmware setting is selected by a user through an on-screen interface of the computing device;
receive a confirmation of change in a value corresponding to the current state of the firmware setting in a Non-Volatile Memory (NVM) associated with a firmware of the computing device; and
in response to the confirmation of the change, execute the change in the current state of the firmware setting in real-time, independent of the working state of the central processing unit.

8. The computing device as claimed in claim 7, wherein the computing device is in one of a game mode and a personal computer mode.

9. The computing device as claimed in claim 7, wherein the on-screen interface is accessed through one of a mechanical push button and a touch panel coupled to a display panel of the computing device.

10. The computing device as claimed in claim 7, wherein the controller is to translate the request so obtained and forward the translated request to a sub-system, the sub-system is in communication with the firmware.

11. The computing device as claimed in claim 7, wherein the firmware setting comprises a wireless charger pad setting, a Universal Serial Bus (USB) fast charging setting, a Bluetooth® speaker setting, a base frequency setting of the central processing unit, a core voltage setting of the central processing unit, and a clock ratio setting of the central processing unit.

12. A non-transitory computer-readable medium comprising computer-readable instructions, which, when executed by a controller, cause a computing device to:
in a sleeping state of a processing resource of the computing device, receive a request to change a firmware setting of the computing device, wherein the request is obtained through a display panel of the computing device;
based on the request, send an instruction to change a value corresponding to the firmware setting in a Non-Volatile Memory (NVM) associated with a firmware of the computing device in the sleeping state of the processing resource; and
upon receiving a confirmation of change in the value, provide a notification on the display panel indicating the change in the firmware setting in real-time, while the processing resource remains in the sleeping state.

13. The non-transitory computer-readable medium as claimed in claim 12, wherein the computing device is in one of a monitor mode and a speaker mode.

14. The non-transitory computer-readable medium as claimed in claim 12, wherein the sleeping state of the processing resource comprises one of a suspend to Random Access Memory (RAM) (S3) state, a hibernation (S4) state, a soft off (S5) state, and a low power idle (Modern Standby) state.

15. The non-transitory computer-readable medium as claimed in claim 12, wherein the firmware setting comprises a wireless charger pad setting, a Universal Serial Bus (USB) fast charging setting, a Bluetooth® speaker setting, a base frequency setting of the processing resource, a core voltage setting of the processing resource, and a clock ratio setting of the processing resource.
